(19) United States
(12) Patent Application Publication
(10) Pub. No.: US 2026/0086388 A1
(43) Pub. Date: Mar. 26, 2026

(54) ANTIMICROBIAL EYEWEAR

(71) Applicant: Bex Sunglasses, LLC, Logandale, NV (US)

(72) Inventor: Jason Adams, Logandale, NV (US)

(73) Assignee: Bex Sunglasses, LLC, Logandale, NV (US)

(21) Appl. No.: 19/334,854

(22) Filed: Sep. 20, 2025

Related U.S. Application Data
(60) Provisional application No. 63/697,283, filed on Sep. 20, 2024.
(60) Provisional application No. 63/704,928, filed on Oct. 8, 2024.

(51) Int. Cl. G02C 5/00; A01N 33/12; A01N 59/00; A01N 59/16; A01N 59/20; A01P 1/00

(52) U.S. Cl. CPC G02C 5/008; A01N 33/12; A01N 59/00; A01N 59/16; A01N 59/20; A01P 1/00

(57) ABSTRACT

Antimicrobial eyewear features frames infused with or coated with antimicrobial additives, thereby offering continuous protection by actively destroying and inhibiting the growth of bacteria, fungi, parasites, and some viruses. The lenses may also have an antibacterial coating that destroys and inhibits bacterial growth. In some examples, the lenses are treated with a specialized strengthening liquid, wherein the liquid contains nano components that release heavy metal ions capable of invading the cell walls of bacteria, leading to bacterial elimination, destroying DNA molecules and proteases within the bacterial cells, denature viral proteins, break DNA chains, and result in cell death. Additionally, the strengthening liquid reduces dehydrogenase activity and interacts with various protein groups within the cell, thereby reducing the activity of these groups and effectively inhibiting the growth of E. coli and other bacteria on the lens surface.

### CROSS-REFERENCE TO RELATED APPLICATIONS

This application claims the benefit of U.S. Provisional Application Ser. No. 63/704,928 filed on Oct. 8, 2024, and further claims the benefit of U.S. Provisional Application Ser. No. 63/697,283, filed on Sep. 20, 2024, both of which are incorporated herein by reference.

### TECHNICAL FIELD

The present disclosure relates to eyewear. More particularly, the present disclosure relates to antimicrobial frames and lenses for eyewear.

### BACKGROUND

Eyewear is an essential accessory for many individuals, encompassing a wide range of products from corrective lenses to sunglasses. These items are indispensable for improving vision, protecting eyes from harmful ultraviolet rays, and reducing glare. However, despite their utility, eyewear can also pose significant health risks due to their potential to serve as vectors for germ transmission.

A common issue with eyewear is the frequent contact between a user's hands and the frames or lenses. This contact can lead to contamination, especially in situations where users are unable to wash their hands regularly or properly, such as during outdoor activities like camping or boating. The hands can transfer microorganisms, including bacteria, viruses, and other harmful germs or substances, onto the eyewear.

Once contaminated, eyewear frames and lenses can become carriers of these microorganisms. This is particularly concerning due to the close proximity of eyewear to the eyes, nose, and ears. These areas are critical entry points for pathogens and are highly susceptible to infections. The transmission of bacteria and viruses through contaminated eyewear can lead to various health issues, ranging from mild irritations to severe infections.

Given the potential health risks associated with germ transmission through eyewear, there is a pressing need for innovative solutions that can destroy, inhibit, or otherwise reduce the growth of microorganisms on eyewear frames. Addressing this issue is crucial to enhancing the safety and hygiene of eyewear, thereby protecting users from potential infections and promoting overall public health. The present disclosure seeks to solve these and other problems.

### SUMMARY OF EXAMPLE EMBODIMENTS

In some embodiments, eyewear comprises frames infused with, or otherwise comprising, antimicrobial additives, thereby offering continuous protection by actively destroying and inhibiting the growth of bacteria, fungi, parasites, and some viruses. In some embodiments, the lenses comprise an antibacterial coating that destroys and inhibits bacterial growth.

In some embodiments, eyewear comprises frames and/or lenses treated with a specialized strengthening liquid (e.g., clearcoat), wherein the liquid contains nano components that release heavy metal ions (e.g., Ag+). These ions are capable of invading the cell walls of bacteria, leading to bacterial elimination. The ions destroy DNA molecules and proteases within the bacterial cells, denature viral proteins, break DNA chains, and result in cell death. Additionally, the strengthening liquid reduces dehydrogenase activity and interacts with various protein groups within the cell, thereby reducing the activity of these groups and effectively inhibiting the growth of E. coli and other bacteria on the lens surface.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,”etc.).

As previously discussed, there is a need for innovative solutions that can destroy, inhibit, or otherwise reduce the growth of microorganisms on eyewear frames. Addressing this issue is crucial to enhancing the safety and hygiene of eyewear, thereby protecting users from potential infections and promoting overall public health. The eyewear disclosed herein solves these problems and others.

In some embodiments, eyewear comprises frames infused with antimicrobial additives, thereby offering continuous protection by actively destroying and inhibiting the growth of bacteria, fungi, parasites, and some viruses. In some embodiments, the antimicrobial additives may comprise one or more of the following: Silver Ions (Ag+), Copper and Copper Alloys, Zinc Oxide (ZnO), Quaternary Ammonium Compounds (Quats), Titanium Dioxide (TiO₂), Organosilane Quaternary Ammonium Compounds, or other substances capable of being infused into plastic and destroying or inhibiting growth of bacteria, fungi, parasites, and viruses.

For example, during the manufacturing process, antimicrobial additives may be added to the liquid composition/resin that will harden and result in the eyewear frames. For example, if the frames are made of plastics, the antimicrobial additives (e.g., silver ions) may be added to the liquid plastic composition before being molded into the frames, thereby embedding the antimicrobial additives into the resulting frames. As a result, the antimicrobial ions are permanently embedded in the frames, providing for continued antimicrobial effects.

In some embodiments, the antimicrobial additives are applied after the frames have been molded and hardened, such as by dipping, spraying, or otherwise applying a coating comprising the antimicrobial additives (referred to as an “antimicrobial coating”) to the completed frames, and allowing the antimicrobial coating to harden or cure. The antimicrobial coating is preferably at least semi-permanent or, most preferably, permanent so as to provide long-lasting or permanent antimicrobial effects, respectively. In some embodiments, the lenses comprise the antimicrobial coating, or an antibacterial coating that destroys and inhibits bacterial growth.

In some embodiments, eyewear (e.g., sunglasses, corrective vision glasses, augmented reality headsets, etc.) comprises lenses treated with a specialized strengthening liquid, wherein the liquid contains nano components that release heavy metal ions (e.g., silver ions). These ions are capable of invading the cell walls of bacteria, leading to bacterial elimination. The ions destroy DNA molecules and proteases within the bacterial cells, denature viral proteins, break DNA chains, and result in cell death. Additionally, the strengthening liquid reduces dehydrogenase activity and interacts with various protein groups within the cell, thereby reducing the activity of these groups and effectively inhibiting the growth of E. coli and other bacteria on the lens surface. The strengthening liquid may be applied by dipping, spraying, or otherwise applying a coating to the lenses and allowing the strengthening liquid to harden or cure. The hardened coating may be polished to ensure no visual interruptions to a user.

In some embodiments, an antimicrobial coating may be applied to the frames, lenses, or both. The antimicrobial coating may comprise one or more of Silver Ions (Ag+), Copper and Copper Alloys, Zinc Oxide (ZnO), Quaternary Ammonium Compounds (Quats), Titanium Dioxide (TiO₂), Organosilane Quaternary Ammonium Compounds, and/or Polymers with Embedded Antimicrobial Agents. The antimicrobial coating may be applied by dipping, spraying, or otherwise applying a coating to the frames and/or lenses, and allowing the coating to harden or cure.

In some embodiments, the antimicrobial coating may comprise a clear carrier (e.g., clearcoat) that is designed to harden/cure, with one or more antimicrobial additives added to the clear carrier prior to application to the eyewear. In some embodiments, the antimicrobial additives may be added to the paint used on the frames of the eyewear. In some embodiments, an additional carrier may be beneficial or necessary, such as when silver ions (Ag+) are used as the antimicrobial additive. Silver ions are electrically-charged and have a high chemical reactivity, and therefore do not exist stably without adhering to a carrier. Therefore, in some embodiments, the carrier may be a powder, resin, fabric fiber, or other suitable carrier for Ag+ and similar additives. In some embodiments, the carrier may be a glass powder, with the glass powder then added to a paint or clearcoat for the eyewear frames. In other words, the silver ions are mixed with, and therefore bind to, the glass powder, to stabilize the silver ions. The combined silver ions and glass powder may then be added to the paint or a clearcoat, thereby providing the antimicrobial properties to the eyewear frames when applied.

This antimicrobial coating effectively inhibits the growth of harmful microbes, including bacteria, viruses, and fungi, thereby reducing the risk of skin irritation, infections, and other health concerns associated with contaminated eyewear. The antimicrobial coating is preferably hypoallergenic, anti-reactive, and resistant to environmental factors such as UV light, sweat, and water, ensuring long-lasting durability.

As discussed above, the antimicrobial coating may be seamlessly integrated into the manufacturing process, including embedding in the eyewear frames or applying an antimicrobial coating to the frames via paint, clearcoat, etc. When the antimicrobial coating is added to the paint for the frames or applied as an additional layer/coating for the frames, the eyewear's aesthetic qualities remain uncompromised while simultaneously providing for antimicrobial effects. This lifetime protection enhances consumer confidence, providing peace of mind through a thoughtful, health-conscious design.

As a result, the eyewear with associated antimicrobial additives and/or coatings disclosed herein solves the need for innovative solutions that can destroy, inhibit, or otherwise reduce the growth of microorganisms on eyewear frames and lenses. Addressing this issue is crucial to enhancing the safety and hygiene of eyewear, thereby protecting users from potential infections and promoting overall public health.

It will be appreciated that systems and methods according to certain embodiments of the present disclosure may include, incorporate, or otherwise comprise properties or features (e.g., components, members, elements, parts, and/or portions) described in other embodiments.

Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. Antimicrobial eyewear, comprising:
eyewear frames comprising one or more antimicrobial additives; and
lenses coupled to the eyewear frames.

2. The antimicrobial eyewear of claim 1, wherein the one or more antimicrobial additives are embedded in the eyewear frames.

3. The antimicrobial eyewear of claim 2, wherein the one or more antimicrobial additives is selected from a group consisting of Silver Ions (Ag+), Copper and Copper Alloys, Zinc Oxide (ZnO), Quaternary Ammonium Compounds (Quats), Titanium Dioxide (TiO₂), and Organosilane Quaternary Ammonium Compounds.

4. The antimicrobial eyewear of claim 1, wherein the one or more antimicrobial additives are applied to an exterior of the eyewear frames.

5. The antimicrobial eyewear of claim 4, further comprising a glass powder combined with the antimicrobial additives, and paint mixed with the glass powder.

6. The antimicrobial eyewear of claim 1, wherein the lenses comprise an antimicrobial coating thereon, the antimicrobial coating comprising one or more antimicrobial additives.

7. The antimicrobial eyewear of claim 6, wherein the one or more antimicrobial additives of the antimicrobial coating is selected from a group consisting of Silver Ions (Ag+), Copper and Copper Alloys, Zinc Oxide (ZnO), Quaternary Ammonium Compounds (Quats), Titanium Dioxide (TiO₂), and Organosilane Quaternary Ammonium Compounds.

8. The antimicrobial eyewear of claim 1, wherein the lenses comprise a strengthening liquid, wherein the strengthening liquid comprises nano components configured to release heavy metal ions.

9. The antimicrobial eyewear of claim 1, wherein the one or more antimicrobial additives is silver ions.

10. The antimicrobial eyewear of claim 1, wherein the one or more antimicrobial additives is selected from a group consisting of Silver Ions (Ag+), Copper and Copper Alloys, Zinc Oxide (ZnO), Quaternary Ammonium Compounds (Quats), Titanium Dioxide (TiO₂), and Organosilane Quaternary Ammonium Compounds.

11. Antimicrobial eyewear, comprising:
eyewear frames comprising one or more antimicrobial additives, the one or more antimicrobial additives comprising one or more of:
Silver Ions (Ag+), Copper and Copper Alloys, Zinc Oxide (ZnO), Quaternary Ammonium Compounds (Quats), Titanium Dioxide (TiO₂), and Organosilane Quaternary Ammonium Compounds; and
lenses coupled to the eyewear frames, the lenses comprising an antimicrobial coating thereon.

12. The antimicrobial eyewear of claim 11, wherein the antimicrobial coating comprises one or more antimicrobial additives.

13. The antimicrobial eyewear of claim 11, wherein the one or more antimicrobial additives are embedded in the eyewear frames.

14. The antimicrobial eyewear of claim 11, wherein the one or more antimicrobial additives are applied to an exterior of the eyewear frames.

15. The antimicrobial eyewear of claim 14, further comprising a glass powder combined with the antimicrobial additives, and paint mixed with the glass powder.

16. A method of manufacturing antimicrobial eyewear, the method comprising:
mixing silver ions with a glass powder;
mixing the combined silver ions and glass powder to a paint;
applying the paint to eyewear frames; and
coupling a pair of lenses to the eyewear frames.

17. The method of claim 16, wherein the silver ions may be replaced with, or used in combination with one or more of:
Copper and Copper Alloys, Zinc Oxide (ZnO), Quaternary Ammonium Compounds (Quats), Titanium Dioxide (TiO₂), and Organosilane Quaternary Ammonium Compounds.

18. The method of claim 16, wherein before coupling the pair of lenses to the eyewear frames, coating the pair of lenses with an antimicrobial coating.

19. The method of claim 18, wherein the antimicrobial coating comprises one or more antimicrobial additives, the one or more antimicrobial additives comprising:
Silver Ions (Ag+), Copper and Copper Alloys, Zinc Oxide (ZnO), Quaternary Ammonium Compounds (Quats), Titanium Dioxide (TiO₂), and Organosilane Quaternary Ammonium Compounds.

20. The method of claim 16, wherein before coupling the pair of lenses to the eyewear frames, coating the pair of lenses with a strengthening liquid, wherein the strengthening liquid comprises nano components configured to release heavy metal ions.
